(19) United States
(12) Patent Application Publication
(10) Pub. No.: US 2016/0057436 A1
(43) Pub. Date: Feb. 25, 2016

(54) VIDEO PROCESSING APPARATUS AND VIDEO DISPLAY APPARATUS

(71) Applicant: SHARP KABUSHIKI KAISHA, Osaka (JP)

(72) Inventors: Daisuke KOYANO, Osaka-shi (JP); Akio KITAYA, Osaka-shi (JP)

(73) Assignee: SHARP KABUSHIKI KAISHA, Osaka (JP)

(21) Appl. No.: 14/830,885

(22) Filed: Aug. 20, 2015

Related U.S. Application Data
(60) Provisional application No. 62/131,035, filed on Mar. 10, 2015.

(30) Foreign Application Priority Data
Aug. 22, 2014 (JP) 2014-168947

(51) Int. Cl. H04N 19/187; H04N 19/172; H04N 19/44

(52) U.S. Cl. CPC H04N 19/187; H04N 19/44; H04N 19/172

(57) ABSTRACT

In a video processing apparatus, even when a resolution of a video signal to be decoded is switched, scaling is performed so as to match with a display size of a display portion for outputting to the display portion and the display portion is caused to display a video matching with the display size. A video processing apparatus according to the present invention includes a decoding portion that decodes a video signal, and a scaling portion that applies scaling processing to a video frame indicated by the video signal decoded by the decoding portion. The decoding portion gives resolution information of the video frame indicated by the decoded video signal to the scaling portion, and the scaling portion applies scaling processing to the video frame based on the resolution information.

### CROSS REFERENCE TO RELATED APPLICATIONS

This non-provisional application claims priority under 35 U.S.C. §119 on Patent Application No. 2014-168947 filed in JAPAN on Aug. 22, 2014 and Provisional Application No. 62/131,035 filed in United States on Mar. 10, 2015, the entire contents of which are hereby incorporated herein by reference.

### FIELD OF THE INVENTION

The present invention relates to a video processing apparatus and a video display apparatus provided with the same.

### BACKGROUND OF THE INVENTION

Currently, as a video display apparatus such as a television apparatus, an apparatus provided with a display panel which is compatible with so-called FHD (Full High Definition) having a resolution of 2K1K (1920×1080 pixels) or a display panel having a resolution of 4K2K is being distributed. Here, 4K2K refers to, for example, QFHD (Quad Full High Definition) having the number of pixels (3840×2160 pixels) which is four times that of the FHD and 4K (4096×2160 pixels) which is defined by a standard specification of digital cinema.

Further, as a demand for a higher-definition display panel is being increased, a display panel for displaying an ultrahigh-definition video having the number of pixels (7680×4320 pixels) which is sixteen times that of the FHD (a video having an 8K4K size) and a video having a 16K8K size, which has the further quadruple number of pixels, and a display apparatus provided with such a display panel have been also increasingly developed.

Meanwhile, some video display apparatuses such as television apparatuses and smart phones have a function of reproducing a moving image by streaming through a network for viewing. In recent years, moving images having a resolution of 4K2K, which are distributed via a network, are also increasing. In order for a viewer to view a moving image having a large amount of data like a 4K2K moving image comfortably, communication with a high bit rate is required.

However, actually, a transfer band of moving image data varies depending on a network environment, and when a large variation is caused in a communication speed and the band becomes narrow, transmission is performed by reducing a resolution from 4K2K to the FHD, 720 p or the like. When trying to receive and display such a moving image by a video display apparatus, a display size thereof is to be switched frequently, so that a viewer mistakenly thinks that the video display apparatus malfunctions. Therefore, countermeasures have been taken conventionally, for example, by inserting a black image and displaying that a communication speed is low, that buffering is being performed with an OSD (On Screen Display) image, and the like, when the resolution is reduced.

Accordingly, instead of such countermeasures, it is desired that a video is scaled up to a size matching with a size of a display panel of the video display apparatus and viewed by a viewer.

Further, without limitation to a situation of streaming reproduction as described above, the similar is applied to a situation where a resolution of a video signal to be decoded is switched in a video display apparatus due to some sort of cause.

In addition, when the resolution is reduced, switching of the resolution becomes conspicuous only by performing scaling processing simply, so that it is also desired to obscure such switching of the resolution.

Note that, as a technique regarding scaling when a video is decoded, Japanese Laid-Open Patent Publication No. 2011-120195 discloses a receiving apparatus that acquires, from a layer corresponding to each frame of a video signal, identification information including a format concerning 2D or 3D of a video and a flag indicating switching from a 3D video to a 2D video, and performs spatial or temporal scaling of video data by the video signal based on the identification information. In a scaling portion of the receiving apparatus, when the format of a video is switched between 2D and 3D, parameters for the scaling are switched in accordance with a switching timing.

However, the technique described in Japanese Laid-Open Patent Publication No. 2011-120195 acquires, when decoding a video, the identification information including the format concerning 2D or 3D of the video and the flag indicating switching from the 3D video to the 2D video, and does not solve the problem described above.

### SUMMARY OF THE INVENTION

An object of the present invention is to perform scaling so as to match with a display size of a display portion for outputting to the display portion even when a resolution of a video signal to be decoded is switched in a video processing apparatus.

An object of the present invention is to provide a video processing apparatus, comprising: a decoding portion that decodes a video signal; and a scaling portion that applies scaling processing to a video frame indicated by the video signal decoded by the decoding portion, wherein the decoding portion gives resolution information of the video frame indicated by the decoded video signal to the scaling portion, and the scaling portion applies scaling processing to the video frame based on the resolution information.

Another object of the present invention is to provide the video processing apparatus, wherein the decoding portion adds the resolution information of the video frame indicated by the decoded video signal to a signal of a video frame preceding the video frame by at least one to give to the scaling portion.

Another object of the present invention is to provide the video processing apparatus, wherein the resolution information is added to a signal within a data effective period of the video frame.

Another object of the present invention is to provide the video processing apparatus, wherein the decoding portion has an LVDS (Low Voltage Differential Signaling) transmitting portion that transmits the decoded video signal and the resolution information to the scaling portion, and the scaling portion has an LVDS receiving portion that receives the decoded video signal and the resolution information, which are transmitted by the LVDS transmitting portion.

Another object of the present invention is to provide the video processing apparatus, wherein the decoding portion regards a video signal received by streaming as a decoding target.

Another object of the present invention is to provide a video display apparatus including the video processing apparatus.

### BRIEF DESCRIPTION OF DRAWINGS

FIG. 1 is a block diagram illustrating one configuration example of a video processing apparatus according to a first embodiment of the present invention.

FIG. 2A is a view for explaining a processing example when a band is sufficiently wide in the video processing apparatus of FIG. 1.

FIG. 2B is a view for explaining a processing example when the band is narrow in the video processing apparatus of FIG. 1.

FIG. 3 is a block diagram illustrating one configuration example of a video display apparatus including a video processing apparatus according to a second embodiment of the present invention.

FIG. 4 is a view for explaining one example of a data format of an LVDS signal which is transmitted and received inside the video processing apparatus of FIG. 3.

FIG. 5A is a view for explaining one example of a transferring timing of the LVDS signal which is transmitted and received inside the video processing apparatus of FIG. 3.

FIG. 5B is a schematic view illustrating video frames in a data effective period.

FIG. 6A is a view illustrating one example of a method of dividing the LVDS signal which is transmitted and received inside the video processing apparatus of FIG. 3.

FIG. 6B is a view illustrating another example of the method of dividing the LVDS signal which is transmitted and received inside the video processing apparatus of FIG. 3.

FIG. 7 is a flowchart for explaining a processing example in the video processing apparatus of FIG. 3.

FIG. 8 is a schematic view for explaining a situation of a frame delay in the video processing apparatus of FIG. 3.

### PREFERRED EMBODIMENT OF THE INVENTION

A video processing apparatus according to the present invention is an apparatus which is incorporated in a video display apparatus and performs video processing for causing a display portion of the video display apparatus to perform display. The video processing apparatus is an apparatus which is useful for being incorporated in a video display apparatus particularly such as a television apparatus, and is also applicable to a different apparatus including a display portion, though description will be given below by assuming that a television apparatus is adopted as the video display apparatus. Examples of the different apparatus include a mobile phone (including one called smart phone), and an information processing apparatus such as a desktop personal computer (PC), a mobile PC or a tablet terminal apparatus (tablet terminal).

### First Embodiment

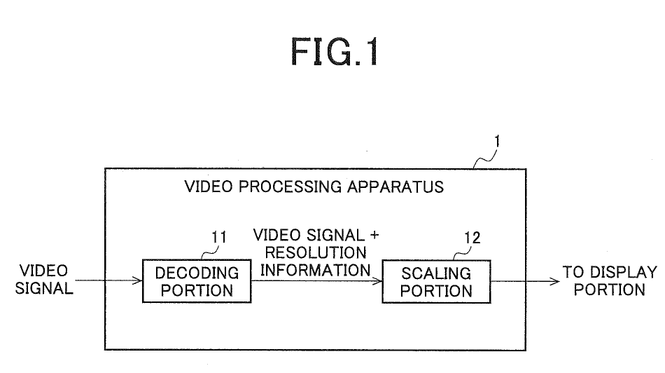

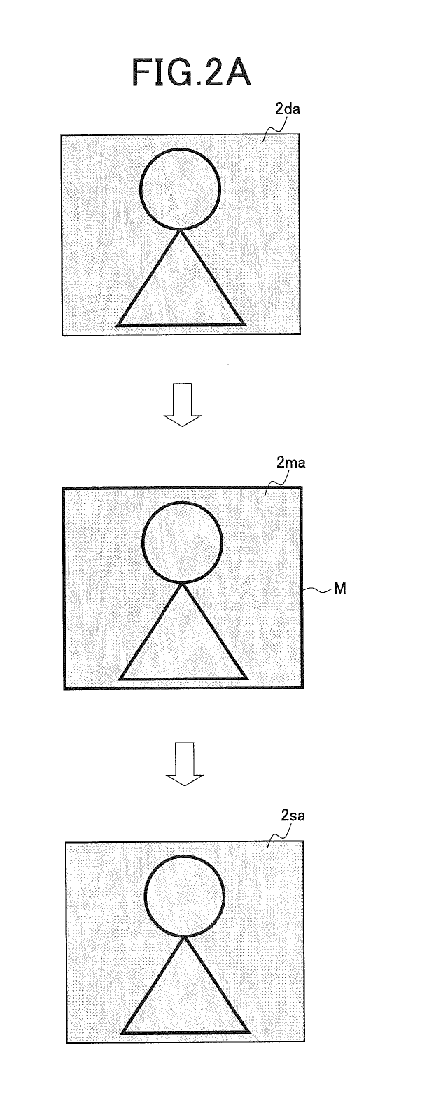

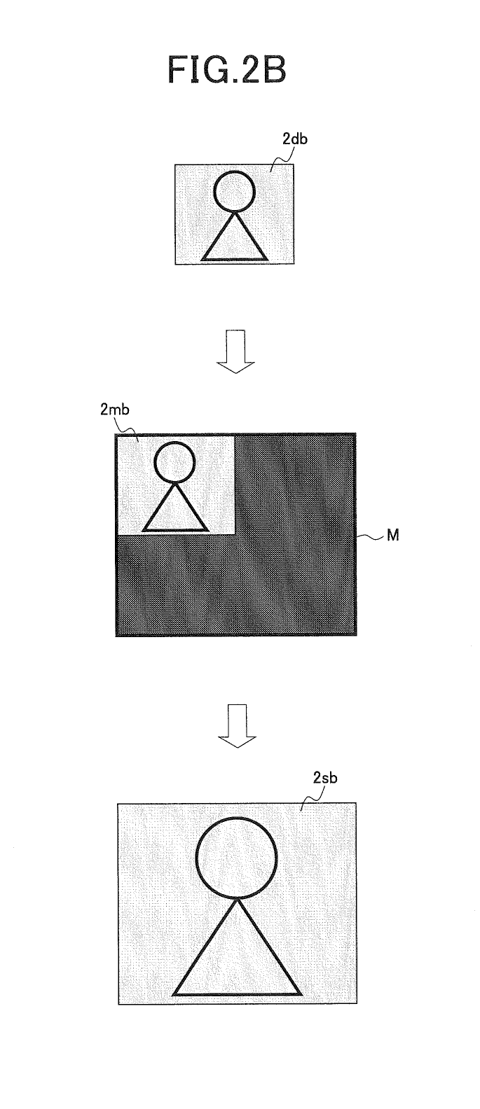

FIG. 1 is a block diagram illustrating one configuration example of a video processing apparatus according to a first embodiment of the present invention. FIG. 2A and FIG. 2B are views for explaining a processing example when a band is sufficiently wide and a processing example when the band is narrow, respectively, in the video processing apparatus of FIG. 1.

As illustrated in FIG. 1, a video processing apparatus 1 according to the present embodiment includes a decoding portion 11 that decodes a video signal, and a scaling portion 12 that applies scaling processing to a video frame indicated by the video signal decoded by the decoding portion 11. Moreover, the video processing apparatus 1 exemplified in FIG. 1 allows connection to a display portion such as a display panel of a television apparatus, and is able to receive a video signal to be subjected to video processing (to be displayed on the display portion).

Note that, the scaling portion 12 is only required to be able to perform scaling of a video frame finally, and may perform not only scaling in a unit of a video frame but also scaling, for example, for each of a front field and a rear field.

As a main feature of the present invention, the decoding portion 11 gives resolution information of the video frame indicated by the decoded video signal to the scaling portion 12, and the scaling portion 12 applies scaling processing to the video frame based on the resolution information. Here, though description is given by assuming that the resolution information is always given to the scaling portion 12, that information may be given only at a timing when a resolution is changed.

The scaling portion 12 may scale the video frame basically by matching with a display size on the display portion. As methods of the scaling, there are bilinear interpolation, Lanczos interpolation and the like, and any method may be adopted without particular prescription.

A case where a video frame 2da which is decoded matches with a display size (resolution) of the display portion will be described with reference to FIG. 2A. The decoding portion 11 maps the decoded video frame 2da onto an internal frame memory (buffer memory) M, transfers a mapping image 2ma to the scaling portion 12, and transfers resolution information, which indicates that a resolution of the video frame 2da is the same as the resolution of the display portion, to the scaling portion 12. In accordance with the resolution information, the scaling portion 12 transfers an image 2sa directly to the display portion without scaling the mapping image 2ma for displaying.

A case where a video frame 2db which is decoded has a resolution smaller than the resolution of the display portion will be described with reference to FIG. 2B. The decoding portion 11 maps the decoded video frame onto a built-in frame memory M (frame memory capable of mapping corresponding to the resolution of the display portion), transfers a mapping image 2mb to the scaling portion 12, and transfers resolution information, which indicates a ratio of the resolution of the video frame 2db to the resolution of the display portion, to the scaling portion 12. In accordance with the resolution information, the scaling portion 12 scales the mapping image 2mb so as to match with the resolution of the display portion, and transfers an image 2sb after the scaling to the display portion for displaying.

Thereby, it makes possible that, in the video processing apparatus, even when a resolution of a video signal to be decoded is switched, scaling is performed so as to match with the display size of the display portion for outputting to the display portion and a video which is scaled up to a size matching with the display size is displayed on the display portion to be viewed by a viewer. Thus, even when the resolution of the video signal to be decoded is switched, it is not necessary to take countermeasures such as inserting a black image nor notifying that a communication speed is low, buffering is being performed or the like with an OSD (On Screen Display) image as in a conventional manner.

### Second Embodiment

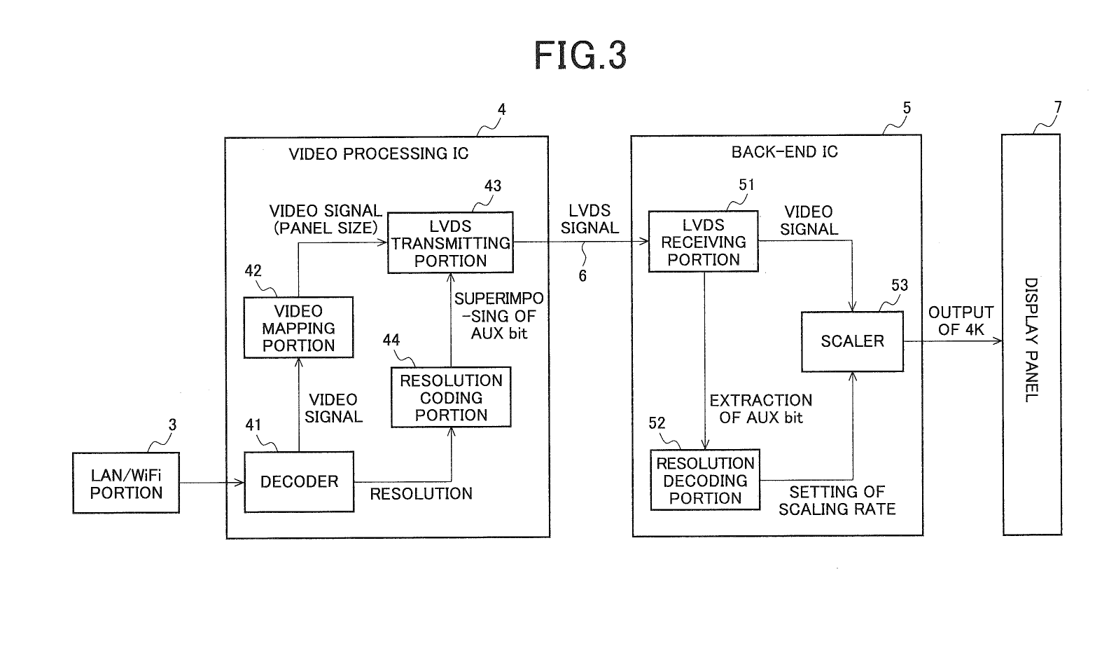

A second embodiment of the present invention will be described with reference to FIG. 3 to FIG. 8 in combination. Though the present embodiment will be described by focusing on a different point from the first embodiment, various application examples described in the first embodiment are also applicable similarly. FIG. 3 is a block diagram illustrating one configuration example of a video display apparatus including a video processing apparatus according to the present embodiment.

The video processing apparatus exemplified in FIG. 3 is formed by connecting a video processing IC (Integrated Circuit) 4 as one example of the decoding portion 11 and a back-end IC 5 as one example of the scaling portion 12 with a conductor signal line 6. The video processing apparatus is provided with a LAN (Local Area Network)/WiFi (registered trademark, the same is applied below) portion 3 at a previous stage of the video processing IC 4, and a video signal which has been received by the LAN/WiFi portion 3 via a LAN or WiFi network is to be processed. Further, the video processing apparatus has a display panel 7, for example, having a 4K2K size connected to a subsequent stage of the back-end IC 5. An apparatus obtained by including the LAN/WiFi portion 3 and the display panel 7 in the video processing apparatus is a video display apparatus.

Note that, the video display apparatus includes a control portion (not illustrated) which controls an entire thereof. The control portion operates, for example, a program stored in a program saving region, and performs various controls for the LAN/WiFi portion 3, the video processing IC 4, the back-end IC 5 and the display panel 7. Therefore, the control portion is composed of, for example, control devices such as a CPU (Central Processing Unit) or an MPU (Micro Processing Unit), a RAM (Random Access Memory) as a working area, and a storage apparatus, and a part or all thereof may be also mounted as an integrated circuit/IC chip set. In the storage apparatus, in addition to a control program, a UI (User Interface) image to be displayed as an OSD image, various setting contents and the like are stored. As the storage apparatus, there is a flash ROM (Read Only Memory), an EEPROM (Electrically Erasable and Programmable ROM) or the like.

The LAN/WiFi portion 3 is one example of a communication portion serving as a communication interface for performing communication with a source device such as an external network server apparatus, a PC in a home network or a recorder device in a wired or wireless manner. Though description will be given below by exemplifying the LAN/WiFi portion 3 as the communication portion, a communication portion which employs a communication standard other than LAN and WiFi may be adopted.

The LAN/WiFi portion 3 gives to the video processing IC 4 with a video signal, which has been received by a streaming method through a LAN or WiFi network, as a decoding target. A protocol of the streaming is not particularly limited, and various protocols such as RTSP (Real Time Streaming Protocol), and HTML (Hyper Text Markup Language) 5 Media Source Extensions are able to be adopted. Note that, as the streaming method, in addition to a method generally called streaming, for example, progressive download, a method in which band control is added to the progressive download, and the like are also applicable.

Even with a setting that, for example, a video having a 4K2K size is received, the LAN/WiFi portion 3 is forced to receive a video having a size not more than FHD according to a communication band in some cases. For determining a communication speed, basically, a network server apparatus serving as a source device of a video and the LAN/WiFi portion 3 may only perform negotiation.

As the display panel 7, there are panels of various display methods, such as a liquid crystal display and an organic electroluminescence display, and when a non-light-emitting display panel such as a liquid crystal display is employed, a not-illustrated backlight apparatus is provided therein.

As a main feature of the present embodiment, the decoding portion 11 gives the resolution information of a video frame indicated by a video signal which has been decoded to the scaling portion 12, by adding to a signal of a video frame at least one piece before the video frame.

The configuration example of FIG. 3 will be described specifically. The video processing IC 4 as one example of the decoding portion 11 includes a decoder 41, a video mapping portion 42, an LVDS (Low Voltage Differential Signaling) transmitting portion 43, and a resolution coding portion 44. Note that, the video processing IC 4 may be said as being a video reproducing portion (moving image reproducing portion). Moreover, the back-end IC 5 as one example of the scaling portion 12 includes an LVDS receiving portion 51, a resolution decoding portion 52, and a scaler 53. The video processing IC 4 and the back-end IC 5 may be arranged on separate IC chips or arranged on the same IC chip.

In this manner, the video processing apparatus in the configuration example of FIG. 3 includes the LVDS transmitting portion 43 and the LVDS receiving portion 51 as the communication portion for transferring the resolution information from the decoding portion 11 to the scaling portion 12.

Note that, when an FRC (Frame Rate Converter) which causes a video frame to have an R-times speed (R is a positive real number) is mounted, it may be mounted in a subsequent stage of the scaler 53 in the back-end IC 5. The FRC is also able to be mounted between the decoder 41 and the LVDS transmitting portion 43 of the video processing IC 4, and in such a case, the resolution information is caused to be associated with an increase in the number of video frames. For example, when doubling the number of video frames, the same resolution information may be added to two video frames.

The video processing IC 4 will be described in detail. The decoder 41 decodes a video signal received by the LAN/WiFi portion 3, gives the video signal itself to the video mapping portion 42, and gives the resolution information to the resolution coding portion 44. Here, the resolution information is able to be discriminated from the decoded video frame or a result of the negotiation with the LAN/WiFi portion 3. This discrimination may be performed by the decoder 41.

Decoding is to be performed in the decoder 41 consequently with a resolution indicated by the resolution information. That is, a size of the video frame to be decoded is determined depending on a state of a signal receiving band at the LAN/WiFi portion 3, and, for example, becomes 4K2K when the band is wide and FHD or less when the band is narrow. As an example of the resolution information, for example, it may be determined such that, for example, 4K2K is {1, 1}, FHD is {1, 0}, 720 P is {0, 1}, and 480 P is {0. 0}.

The video mapping portion 42 maps the video frame indicated by the video signal decoded by the decoder 41 onto an internal frame memory M to give to the LVDS transmitting portion 43. Here, the internal frame memory M in the video mapping portion 42 is able to accumulate an image having a maximum resolution which is able to be displayed on the display panel 7 (for example, an image having a 4K2K size).

More specifically, the video mapping portion 42 maps the video frame indicated by the decoded video signal onto the internal frame memory M matching the resolution of the display panel 7 to thereby process the video frame to have the resolution of the display panel 7.

A case where the resolution of the display panel 7 is 4K2K will be described. When the resolution of the decoded video frame is also 4K2K, the 4K2K size is kept as it is (corresponding to the mapping image 2ma of FIG. 2A), and when the resolution of the decoded video frame is FHD, superimposing is performed on a part of the internal frame memory M serving as a buffer having a 4K2K size (corresponding to the mapping image 2mb of FIG. 2B). Note that, when the resolution of the display panel 7 is, for example, 8K4K or 16K8K, the internal frame memory M also serves as a buffer having a 8K4K size or a 16K8K size, respectively.

The resolution coding portion 44 codes the resolution information received from the decoder 41 to give to the LVDS transmitting portion 43. In this coding, for example, when the resolution information is {1, 0} indicating FHD, a first AUX (Auxiliary) bit (Reversed bit) may be set as 1 and a second AUX bit may be set as 0, etc., on the basis of being superimposed on a signal of an LVDS method (LVDS signal) at the LVDS transmitting portion 43. The AUX bit will be described below.

The LVDS transmitting portion 43 converts the video frame, which has been mapped at the video mapping portion 42, into an LVDS signal, and further superimposes the AUX bit coded by the resolution coding portion 44 on the LVDS signal. Here, the AUX bit is added to a signal of a video frame at least one piece before the video frame the resolution of which is indicated by the AUX bit. The video frame may accordingly be delayed with respect to the AUX bit at any time point.

For example, when the decoding size is FHD, that is, the resolution information is {1, 0}, by setting the AUX bit of a first pixel of a video frame which has been decoded one piece before to 1 and setting the AUX bit of a second pixel to 0, the resolution information is embedded in the AUX bit of the LVDS signal.

In the present embodiment, the resolution information may not be embedded in the LVDS signal of the video frame which has been decoded one piece before, and may be embedded in an LVDS signal of a video frame which has been decoded N frames before (N is a positive number of 2 or more). By defining, in advance, the number of frames after that of the AUX bit the resolution information is to be embedded in, it is able to be dealt with on the back-end IC 5 side. Note that, a reason why the resolution information is embedded in a top pixel of the video frame is for allowing the back-end IC 5 to recognize the resolution information as soon as possible, and by defining, in advance, at which number it is to be embedded, it is able to be dealt with on the back-end IC 5 side, so that it may be embedded at any number of pixel.

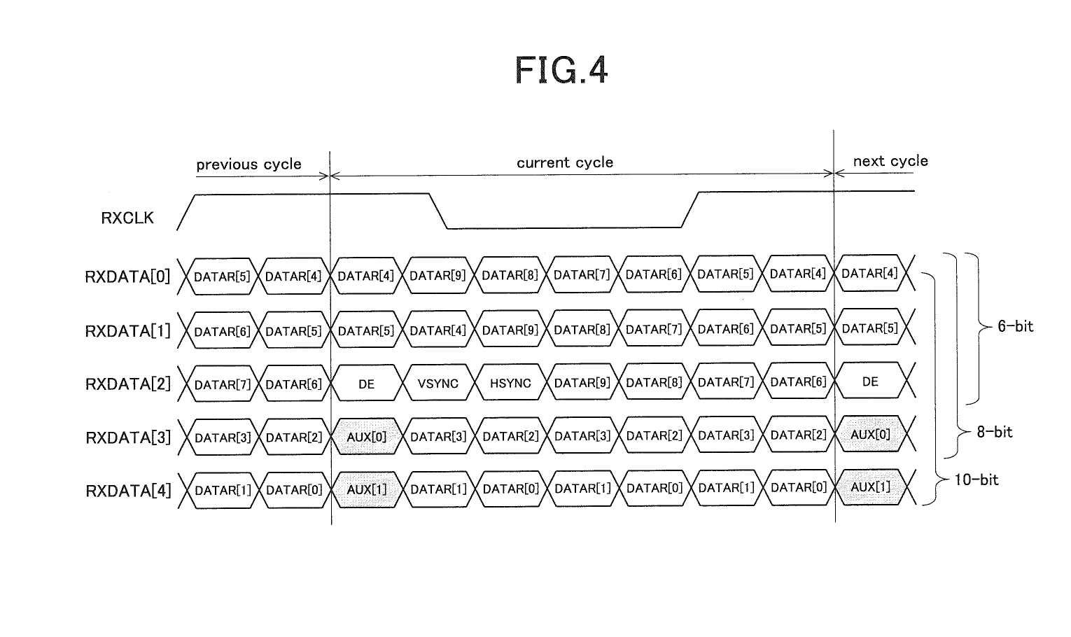

Here, one example of a data format of an LVDS signal will be described with reference to FIG. 4. FIG. 4 is a view for explaining one example of the data format of the LVDS signal which is transmitted and received inside the video processing apparatus of FIG. 3.

In the data format of the LVDS signal exemplified in FIG. 4, one cycle corresponds to one pixel, which is transmitted by one bus and mapped with a JEIDA (Japan Electronics and Information Technology Industries Association) mode of 10 bits.

Among them, a first bit of the resolution information is able to be embedded in AUX [0] and a second bit of the resolution information is able to be embedded in AUX [1]. However, for example, when AUX [0] is used for embedding LR (left and right) information for 3D display, only AUX [1] may merely be used as the resolution information. Note that, the number of the buses in the signal line 6 is not limited to one, and may be set as appropriate so as to match a transferring amount (a resolution or a frame rate).

Without limitation to the example of FIG. 4, also in an NS (National Semiconductor) mode in which arrangement of RGB is changed from that of the JEIDA mode, a position of the AUX bit is the same, so that the AUX bit is able to be used similarly as an embedding destination of the resolution information. Note that, in the case of eight bits, the AUX bit has only one bit, so that in the case of the resolution information requiring two bits as described above, it is required for two pixels. Further, in the case of six bits, the AUX bit does not exist, so that the resolution information may be embedded in a part corresponding to a video in a data ineffective period or the resolution information may be transmitted by providing a control line additionally.

Moreover, in the example of FIG. 4, it is assumed that the resolution information is added during a DE [Data Enable] period of the LVDS signal. Like this example, the resolution information is preferably added to a signal in a data effective period (corresponding to the DE period of the LVDS signal, the similar is applied below) of a video frame. Note that, the data effective period refers to a part in which data of a video to be displayed is described.

For example, in a system in which conversion is performed into a signal compatible with V-by-one (registered trademark), a signal compatible with V-by-one (registered trademark) HS, or the like right before scaling processing, AUX data during the data ineffective period is discarded before performing scaling. When trying to prevent missing of resolution information in consideration of even mounting of such a system in which the AUX bit is discarded, it may be said that the resolution information is preferably embedded in the AUX bit in the data effective period. Of course, the resolution information may be added to a signal in the data ineffective period.

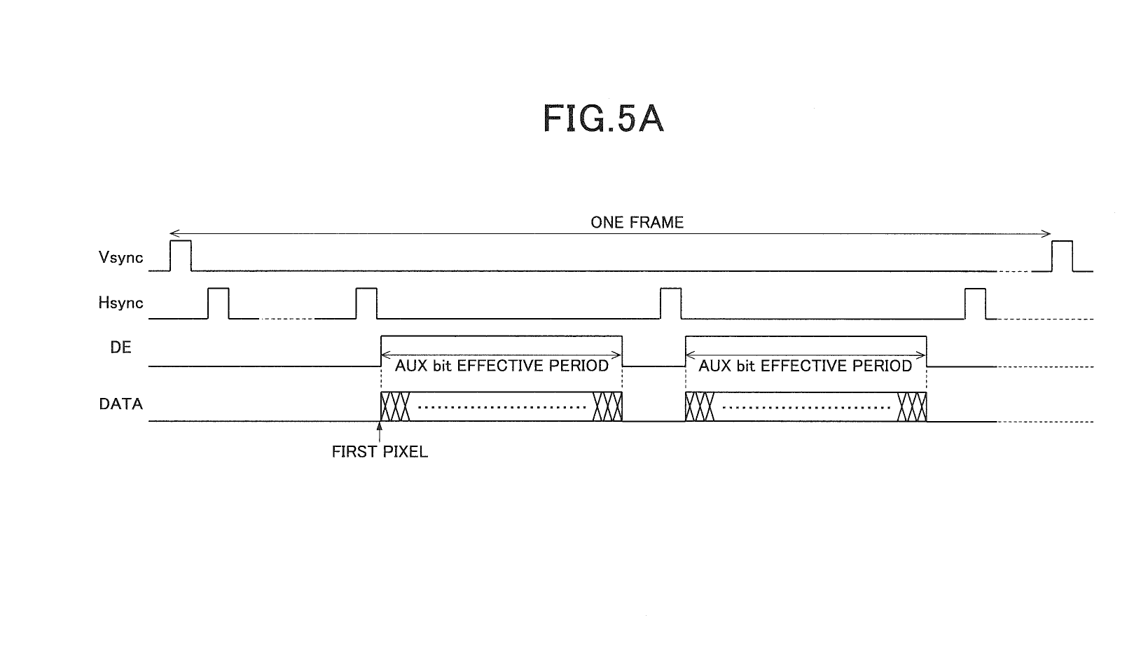

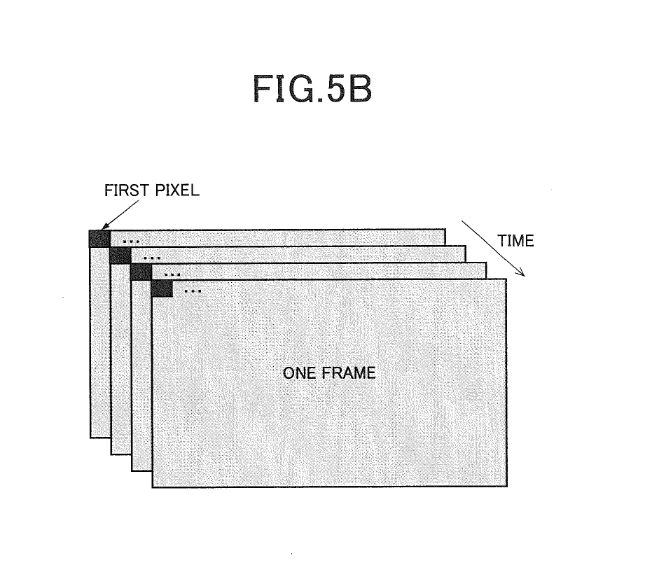

A transferring timing of such an LVDS signal will be described with reference to FIG. 5A and FIG. 5B. FIG. 5A is a view for explaining one example of the transferring timing of the LVDS signal which is transmitted and received inside the video processing apparatus of FIG. 3, and FIG. 5B is a schematic view illustrating video frames in a data effective period.

The transferring timing exemplified in FIG. 5A is for one frame sectioned by Vsnyc, in which resolution information is embedded in an AUX bit of a first pixel during the DE period after the non-DE period has lapsed. That is, in this example, the DE period corresponds to an effective period of the AUX bit. The first pixel in the DE period is a pixel illustrated in FIG. 5B. Of course, RGB data is also described in each pixel during the DE period. In this manner, since the LVDS signal has the AUX bit existing within the DE period, the resolution information is able to be embedded in the AUX bit.

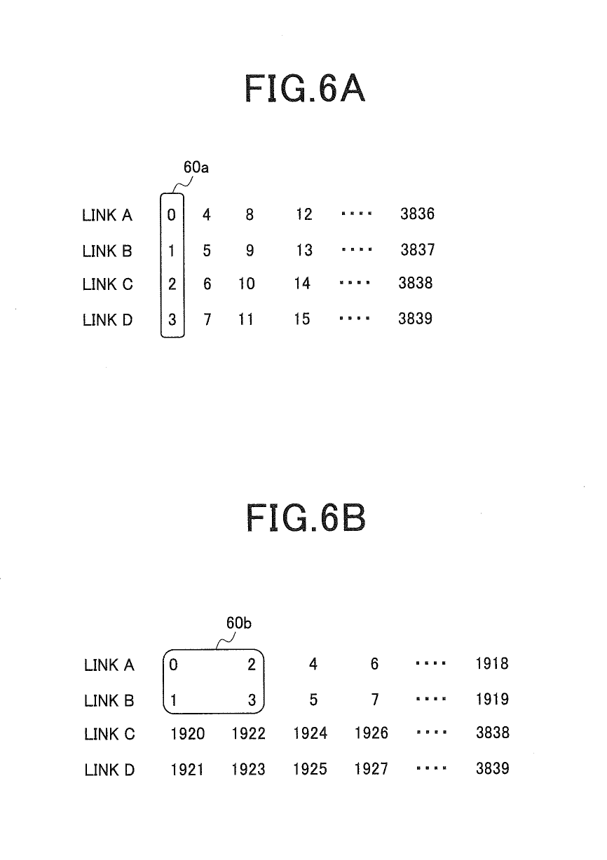

Then, the LVDS transmitting portion 43 transmits the LVDS signal to be transmitted (the decoded video signal and the resolution information) to the LVDS receiving portion 51 on the back-end IC 5 side through the signal line 6. Any method of dividing the signal may be used at the time of transmission. An example of the method of dividing the LVDS signal will be described with reference to FIG. 6A and FIG. 6B. FIG. 6A is a view illustrating one example of the method of dividing the LVDS signal which is transmitted and received inside the video processing apparatus of FIG. 3, and FIG. 6B is a view illustrating another example thereof.

The LVDS signal to be transmitted may be transferred by dividing sequentially as illustrated in FIG. 6A or may be transferred by dividing a video frame into right and left (a left-half pixel group and a right-half pixel group) as illustrated in FIG. 6B. Both of the examples of FIG. 6A and FIG. 6B take an example of the LVDS signal that a 4K2K video is transmitted by each of four buses (LINKs). An output is performed, for example, with a frame rate of 30 Hz by the four LINKs.

In the example of FIG. 6A, a pixel group of a video frame is transferred in turn by the four buses LINKs A to D, and, for example, when the resolution information needs four bits, the resolution information is transmitted by first four pixels 60a. In the example of FIG. 6B, which is the same as the example of FIG. 6A in that the pixel group of the video frame is transferred by the four buses LINKs A to D, the left-half pixel group is transferred by the LINKs A and B and the right-half pixel group is transferred by the LINKs C and D. For example, when the resolution information needs four bits, the resolution information is transmitted by first four pixels 60b of the left-half pixel group.

Next, the back-end IC 5 will be described in detail. The LVDS receiving portion 51 receives the LVDS signal (the decoded video signal and the resolution information) transmitted through the signal line 6 from the LVDS transmitting portion 43, to give to the resolution decoding portion 52 and the scaler 53.

At that time, the LVDS receiving portion 51 extracts the AUX bit, in which the resolution information is described, from the received LVDS signal, gives the extracted AUX bit to the resolution decoding portion 52, and gives a video signal of the received LVDS signal to the scaler 53. At which position the resolution information is to be add is known in advance, so that it is possible to extract the AUX bit in which the resolution information is described.

For example, with respect to the LVDS signal as illustrated in FIG. 5A, by extracting AUX bits of the required number which is defined in advance from a first pixel in the DE period, the resolution information is able to be acquired. Moreover, when the dividing method of FIG. 6A is adopted and the resolution information needs four bits, by extracting AUX bits from four pixels 60a in total of the first pixels of the respective LINKs A to D, the resolution information is able to be acquired. When the dividing method of FIG. 6B is adopted and the resolution information needs four bits, by extracting AUX bits from four pixels 60b in total of the first pixels and second pixels of the respective LINKs A and B, the resolution information is able to be acquired.

The resolution decoding portion 52 decodes the AUX bit extracted by the LVDS receiving portion 51, and decides a resolution indicated by the AUX bit. The AUX bit to be decoded may be only for pixels of the number which is defined in advance, and the resolution decoding portion 52 collects the required amount of decoded AUX bits to convert into resolution information. Here, in the example described above, the resolution information may be decided as 4K2K when a decoding result of the AUX bit is {1, 1}, and the decision may be made similarly as FHD in the case of {1, 0}, 720 P in the case of {0, 1}, and 480 P in the case of {0, 0}.

Then, the resolution decoding portion 52 sets a predetermined scaling rate to the scaler 53 based on the decided resolution. For example, when the resolution of the display panel 7 is 4K2K and the resolution information obtained by decoding the AUX bit indicates FHD, the predetermined scaling rate may be set to (resolution of 4K2K)/(resolution of FHD). Similarly, for example, when the resolution of the display panel 7 is 4K2K and the resolution information obtained by decoding the AUX bit also indicates 4K2K, it may be set as (resolution of 4K2K)/(resolution of 4K2K)=1 (that is, set as that scaling is unnecessary). Of course, the setting of the scaling rate does not need to be executed at all times and may be executed only when there is change in the resolution by comparing to a previous frame.

The scaler 53 scales the video frame, which is indicated by the video signal given from the LVDS receiving portion 51, with the predetermined scaling rate to transfer to the display panel 7. Note that, the scaler 53 may transfer the video frame to the display panel 7 with a predefined format, for example, such as LVDS.

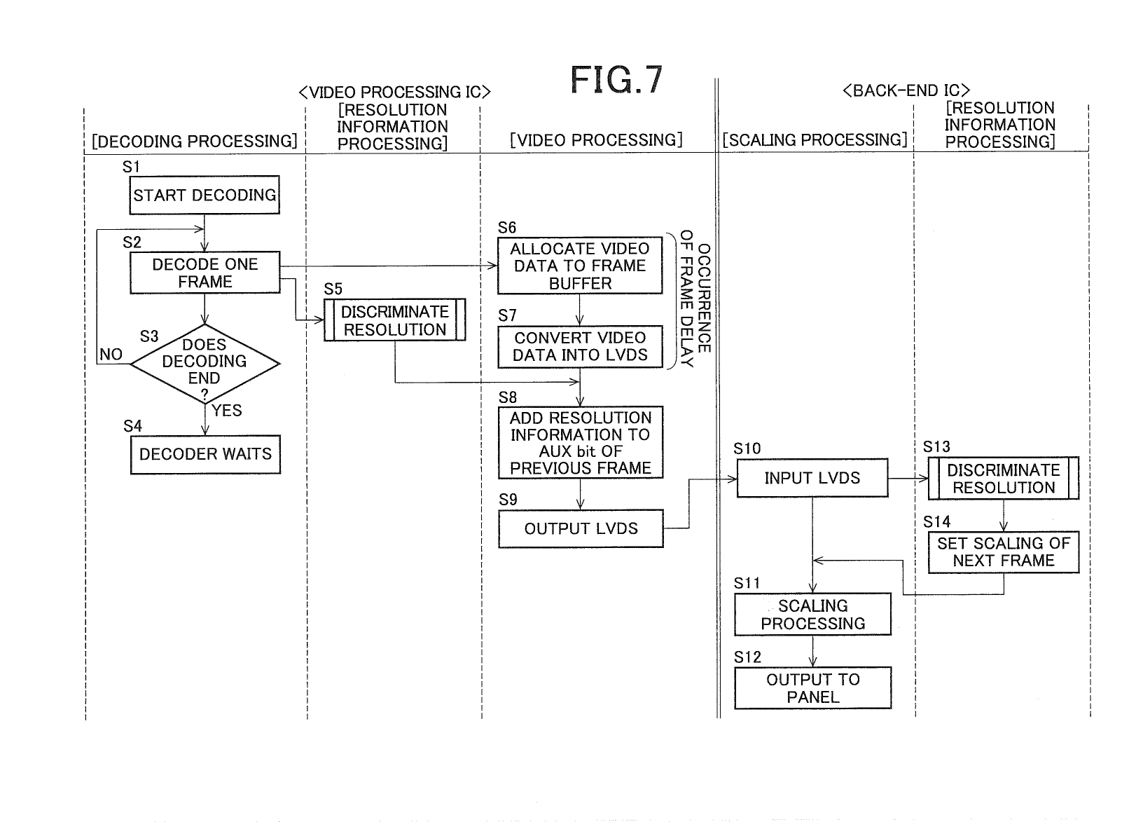

Next, one example of processing in the video processing apparatus as described above will be described with reference to FIG. 7. FIG. 7 is a flowchart for explaining a processing example in the video processing apparatus of FIG. 3. First, processing on the video processing IC 4 side will be described.

The decoder 41 starts decoding (step S1), and executes decoding of one frame (step S2). The decoder 41 decides whether or not the decoding of one frame ends (step S3), and when it ends, waits until a next decoding request (interruption of decoding start) is given (step S4). When there is an interruption of decoding start for a next frame, the processing starts again from step S1. The decoding processing is performed in this manner.

The decoder 41 discriminates a resolution of the video frame which is decoded at step S2 and gives the resolution information indicating the resolution to the resolution coding portion 44, and the resolution coding portion 44 codes the resolution information (step S5). The resolution information processing is performed in this manner.

Moreover, the video mapping portion 42 allocates (maps) the video frame decoded at step S2 onto the frame memory (frame buffer) M, and then gives it to the LVDS transmitting portion (step S6). Subsequent to step S6, the LVDS transmitting portion 43 converts data of the video frame into an LVDS signal (step S7). A delay for one frame is caused by steps S6 and S7. Subsequently, the LVDS transmitting portion 43 adds (embeds) the resolution information which is coded at step S5 to an AUX bit of a frame which is delayed (video frame preceding by one) (step S8). Then, the LVDS transmitting portion 43 outputs the LVDS signal generated at step S8 to the LVDS receiving portion 51 (step S9). The video processing is performed in this manner.

The LVDS signal output from the video processing IC 4 side as described above is received by the LVDS receiving portion 51 on the back-end IC 5 side (step S10). The scaler 53 scales the video frame obtained from the LVDS signal received at step S10 with a scaling rate which is set (step S11) to output to the display panel 7 (step S12). The scaling processing is performed in this manner.

In addition, as the resolution information processing on the back-end IC 5 side, the LVDS receiving portion 51 extracts, from the received LVDS signal, an AUX bit at a position where the resolution information is embedded, and the resolution decoding portion 52 decodes it, so that a resolution of a video frame which is transmitted is discriminated (step S13). The resolution decoding portion 52 sets a scaling rate for a next frame from a result of the discrimination and the resolution of the display panel 7 to the scaler 53 (step S14). The scaling rate which is set here is to be used for scaling for the next frame at step S11.

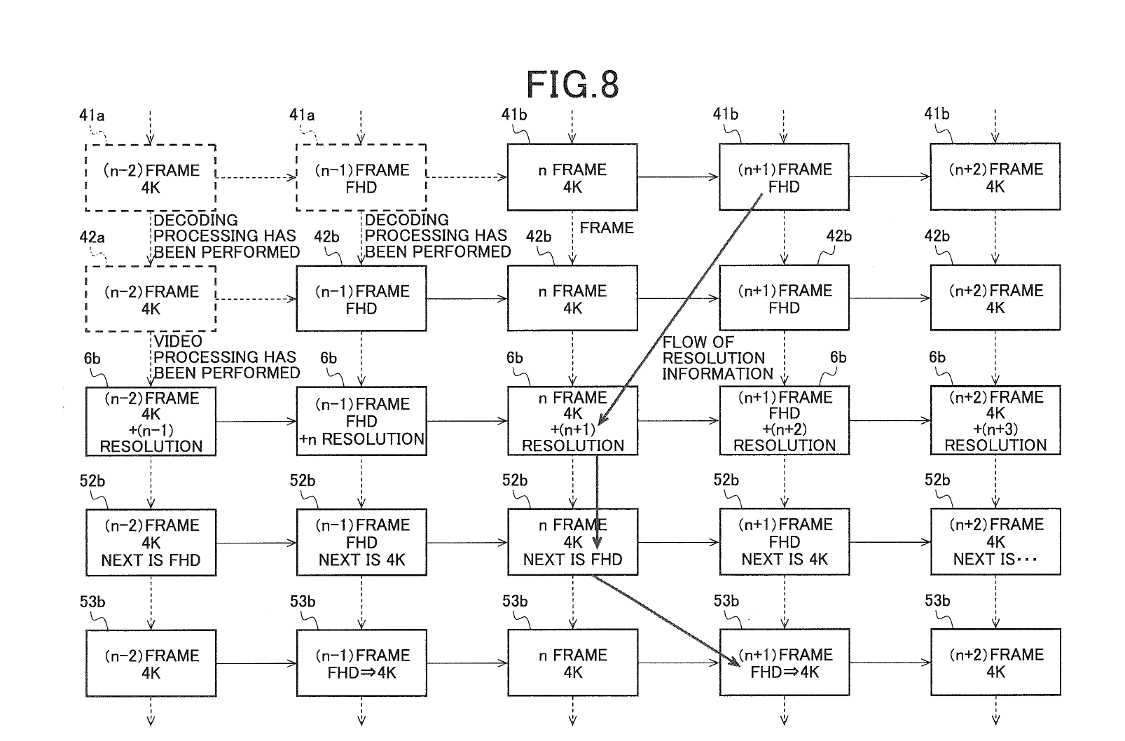

Next, by taking a case where a video signal in which 4K2K and FHD are switched for each one frame as an extreme example, an effect of the present embodiment will be described with reference to FIG. 8. FIG. 8 is a schematic view for explaining a situation of a frame delay in the video processing apparatus of FIG. 3.

In FIG. 8, frames arranged in a horizontal direction refer to frames to which the same processing is applied, and a vertical direction indicates a time lapse thereof. Further, a frame 41a refers to a frame which has been decoded by the decoder 41 (that is, a frame for which the decoding processing of FIG. 7 has been completed) and a frame 41b refers to a frame which is to be decoded. A frame 42a refers to a frame for which the video processing of FIG. 7 has been completed and a frame 42b refers to a frame for which the video processing of FIG. 7 is to be executed. A frame 6b refers to a frame to be transferred from the signal line 6 with resolution information added thereto after the resolution information processing on the video processing IC 4 side in FIG. 7 is applied to the frames 42a and 42b. A frame 52b refers to a frame whose resolution is to be decided after the resolution information processing on the back-end IC 5 side in FIG. 7 is applied to the frame 6b. A frame 53b refers to a frame to which the scaling processing of FIG. 7 is to be applied with the resolution discriminated for the frame 52b. Further, a thick arrow in FIG. 8 indicates a flow of resolution information for an (n+1)-th frame, and the similar is also applied to frames at other times.

As illustrated in FIG. 8, in the video processing IC 4, for example, an (n−2)-th frame 41a is decoded, which is transmitted to the back-end IC 5 with resolution information indicating that a resolution of an (n−1)-th frame 41a is FHD. Here, at a stage where the (n−2)-th frame 41a is decoded and the video processing ends, the (n−1)-th frame 41a has been decoded already and it is possible to discriminate a resolution thereof and code the resolution information.

In the back-end IC 5 which has received it, it has been already known from resolution information added to an (n−3)-th frame that the (n−2)-th frame has 4K2K, so that an output is performed to the display panel 7 having the 4K2K size without performing scaling. Note that, a frame at the time of starting video reception may be determined as having the same resolution as the resolution of the display panel 7, etc.

Then, the (n−1)-th frame 41a is decoded, which is transmitted to the back-end IC 5 with resolution information indicating that a resolution of an n-th frame 41b is 4K2K. Here, at a stage where the (n−1)-th frame 41a is decoded and the video processing ends, the n-th frame 41a has been decoded already and it is possible to discriminate a resolution thereof and code the resolution information.

In the back-end IC 5 which has received it, it has been already known from resolution information added to the (n−2)-th frame that the (n−1)-th frame has FHD, so that an output is performed to the display panel 7 having the 4K2K size by performing scaling from FHD to 4K2K.

As described above, in the present embodiment, since resolution information is added to a frame preceding at least by one, before a change in a resolution is caused, the decoding side is able to notify the scaling processing side of the change and setting of a scaling rate is able to be changed in a unit of a frame on the scaling side, surely with a time margin compared to a case where the resolution information is added to a current frame. In other words, in the present embodiment, an effect that countermeasures such as insertion of a black image nor notification with OSD in the first embodiment are not required is able to be realized without seeking to increase processing speed of the video processing apparatus.

Accordingly, in the present embodiment, even in a situation where a resolution changes, for example, from 4K2K to FHD and then returns to 4K2K, scaling processing suitable for the resolution which changes during at least one frame in which the change is caused is able to be performed, and smooth display is able to be performed apparently with the resolution kept in the 4K2K size without interruption. That is, according to the present embodiment, it is possible to perform reproduction while performing, when a resolution of a video signal to be decoded is reduced and when it is restored, smooth scaling by which switching of the resolution is obscured, without seeking to increase the processing speed.

Moreover, using the LVDS method described above makes it possible to transmit and receive a video signal and resolution information with a general method. Thus, a dedicated control line for transmitting and receiving resolution information becomes unnecessary, and not only components and line materials associated with the control line becomes unnecessary but synchronization between resolution information and a video frame becomes easy to be achieved.

However, it may be configured that a video signal and resolution information are transmitted and received with a method other than LVDS, for example, such as an RSDS (Reduced Swing Differential Signaling) method. The transmission method may be any of parallel one and serial one. Further, a transmission medium may also not be limited to a conductive wire and may be an optical fiber for performing optical communication.

Moreover, description has been given by taking an example that a decoding target of the decoder 41 is a video signal received by streaming. Thereby, since a situation where resolution of the received video signal is switched increases, an effect is more markedly achieved that a video matching with a display size of the display panel 7 is able to be output even in a situation where the resolution of the received video signal is switched.

However, as not particularly referred to in the first embodiment, the decoding target is not limited to reproduction of the video signal received by streaming, and the video processing apparatus of the present invention is able to be used when reproducing any video signal. In other words, a source device of a video signal is not limited to a device in which narrowing of a communication band is caused, such as the network server apparatus described above, and may be, for example, a recorder device which is connected to a video display apparatus with a wide-band cable and the like or may be a storage apparatus provided in the video display apparatus. Further, in a situation where a resolution of a video signal to be decoded in the video processing apparatus is switched due to some sort of cause, an effect similar to the case of streaming reproduction is exerted.

Moreover, in the present embodiment, though description has been given by assuming that resolution information is given to the scaling side at all times, instead, the resolution information may be embedded (that is, information of a change in the resolution is embedded) only at a timing when a resolution is changed. However, in this case as well, it is necessary to check whether or not there exists resolution information (in the example of FIG. 3, processing for extracting the AUX bit in which resolution information is to be embedded) on the receiving side at all times, and when there exists, processing for decoding the resolution information may be performed.

Note that, in a case where FRC is applied when resolution information is embedded only at the time of change in a resolution in this manner, the resolution information does not need to be newly added according to increase in the number of video frames due to FRC, and the resolution information may merely be added to one video frame at the time of change.

### About First and Second Embodiments

As described above, a video processing apparatus of the present invention is a video processing apparatus including a decoding portion that decodes a video signal, and a scaling portion that applies scaling processing to a video frame indicated by the video signal decoded by the decoding portion, in which the decoding portion gives resolution information of the video frame indicated by the decoded video signal to the scaling portion, and the scaling portion applies scaling processing to the video frame based on the resolution information. Thereby, an effect is exerted that, in the video processing apparatus, even when a resolution of a video signal to be decoded is switched, scaling is performed so as to match with a display size of a display portion for outputting to the display portion and the display portion is caused to display a video matching with the display size.

It is preferable that the decoding portion adds the resolution information of the video frame indicated by the decoded video signal to a signal of a video frame preceding the video frame by at least one to give to the scaling portion. Thereby, the aforementioned effect is able to be realized without seeking to increase a processing speed of the video processing apparatus.

It is preferable that the resolution information is added to a signal in a data effective period of the video frame. Thereby, there becomes no risk that the resolution information is discarded before scaling is performed.

It is preferable that the decoding portion has an LVDS (Low Voltage Differential Signaling) transmitting portion that transmits the decoded video signal and the resolution information to the scaling portion, and the scaling portion has an LVDS receiving portion that receives the decoded video signal and the resolution information, which are transmitted by the LVDS transmitting portion. This makes it possible to transmit and receive the video signal and the resolution information with a general method.

It is preferable that the decoding portion regards a video signal received by streaming as a decoding target. Thereby, an effect is more markedly achieved that a video matching with the display size of the display portion is able to be output even when a resolution of the received video signal is switched.

A video display apparatus of the present invention is a video display apparatus including the video processing apparatus. This makes it possible to provide a video display apparatus in which the video processing apparatus exerting the effect as described above is incorporated.

As above, according to the present invention, it is possible that, in a video processing apparatus, even when a resolution of a video signal to be decoded is switched, scaling is performed so as to match with a display size of a display portion for outputting to the display portion and the display portion is caused to display a video matching with the display size.

1. A video processing apparatus, comprising: a decoding portion that decodes a video signal; and a scaling portion that applies scaling processing to a video frame indicated by the video signal decoded by the decoding portion, wherein
the decoding portion gives resolution information of the video frame indicated by the decoded video signal to the scaling portion, and
the scaling portion applies scaling processing to the video frame based on the resolution information.

2. The video processing apparatus according to claim 1, wherein
the decoding portion adds the resolution information of the video frame indicated by the decoded video signal to a signal of a video frame preceding the video frame by at least one to give to the scaling portion.

3. The video processing apparatus according to claim 2, wherein
the resolution information is added to a signal within a data effective period of the video frame.

4. The video processing apparatus according to claim 1, wherein
the decoding portion has an LVDS (Low Voltage Differential Signaling) transmitting portion that transmits the decoded video signal and the resolution information to the scaling portion, and
the scaling portion has an LVDS receiving portion that receives the decoded video signal and the resolution information, which are transmitted by the LVDS transmitting portion.

5. The video processing apparatus according to claim 2, wherein
the decoding portion has an LVDS (Low Voltage Differential Signaling) transmitting portion that transmits the decoded video signal and the resolution information to the scaling portion, and
the scaling portion has an LVDS receiving portion that receives the decoded video signal and the resolution information, which are transmitted by the LVDS transmitting portion.

6. The video processing apparatus according to claim 3, wherein
the decoding portion has an LVDS (Low Voltage Differential Signaling) transmitting portion that transmits the decoded video signal and the resolution information to the scaling portion, and
the scaling portion has an LVDS receiving portion that receives the decoded video signal and the resolution information, which are transmitted by the LVDS transmitting portion.

7. The video processing apparatus according to claim 1, wherein
the decoding portion regards a video signal received by streaming as a decoding target.

8. The video processing apparatus according to claim 2, wherein
the decoding portion regards a video signal received by streaming as a decoding target.

9. The video processing apparatus according to claim 3, wherein
the decoding portion regards a video signal received by streaming as a decoding target.

10. The video processing apparatus according to claim 4, wherein
the decoding portion regards a video signal received by streaming as a decoding target.

11. The video processing apparatus according to claim 5, wherein
the decoding portion regards a video signal received by streaming as a decoding target.

12. The video processing apparatus according to claim 6, wherein
the decoding portion regards a video signal received by streaming as a decoding target.

13. A video display apparatus including the video processing apparatus according to claim 1.

14. A video display apparatus including the video processing apparatus according to claim 2.

15. A video display apparatus including the video processing apparatus according to claim 3.

16. A video display apparatus including the video processing apparatus according to claim 4.

17. A video display apparatus including the video processing apparatus according to claim 5.

18. A video display apparatus including the video processing apparatus according to claim 6.

19. A video display apparatus including the video processing apparatus according to claim 7.

20. A video display apparatus including the video processing apparatus according to claim 8.
